(19) United States
(12) Patent Application Publication
(10) Pub. No.: US 2025/0237410 A1
(43) Pub. Date: Jul. 24, 2025

(54) LIQUID HEATING DEVICE

(71) Applicant: Niterra Co., Ltd., Nagoya-shi, Aichi (JP)

(72) Inventors: Yusuke MAKINO, Nagoya-shi, Aichi (JP); Yuya HIGASHIDE, Nagoya-shi, Aichi (JP)

(73) Assignee: Niterra Co., Ltd., Nagoya-shi, Aichi (JP)

(21) Appl. No.: 18/703,467

(22) PCT Filed: Oct. 31, 2022
(86) PCT No.: PCT/JP2022/040636

§ 371 Date: Apr. 22, 2024

(30) Foreign Application Priority Data
Apr. 14, 2022 (JP) 2022-066817

(51) Int. Cl. F24H 15/128; F24H 1/10; F24H 9/20

(52) U.S. Cl. CPC F24H 15/128; F24H 1/102; F24H 9/2028

(57) ABSTRACT

A liquid heating device 200 including: a container 100 having an internal space 100i; a plurality of ceramic heaters 171-172 extend in a front-rear direction L and whose front-end portions are located in the internal space; and a safety device 150 configured to interrupt energization to the ceramic heaters when a temperature of the container has exceeded a set value, wherein the safety device whose number is smaller than a number of the ceramic heaters is provided on an outer side of the container or buried in the container, and in a cross-section crossing the front-rear direction, one safety device is provided inside an area R1 between two lines S1,S2 which pass centers of gravity G1, G2 of at least a pair of two adjacent ones of the ceramic heaters and which are perpendicular to a segment M1 connecting the centers of gravity.

### TECHNICAL FIELD

The present invention relates to a ceramic heater suitable for heating a liquid such as water, and a liquid heating device using the same.

### BACKGROUND ART

Warm water is needed for a warm water washing toilet seat, a fuel cell system, a water heater, a 24-hour bath system, heating of a washer fluid for a vehicle, an in-vehicle air conditioner, and the like. Accordingly, a liquid heating device which heats water by a built-in heater is used.

In particular, for the purpose of rapid heating for warm water of a warm water washing toilet seat, etc., a rod-shaped ceramic heater having a heat generation portion embedded in a ceramic sheet wrapped around the outer circumference of an elongated ceramic base is used.

If water in the liquid heating device is reduced and the heater is energized in a no-water heated state, the temperature abnormally increases, so that the liquid heating device storing the heater is overheated. Accordingly, technology of providing a safety device (such as thermal fuse) for interrupting energization to a heater when the temperature of the heater has abnormally increased and thus a device temperature has become high, is developed (Patent Document 1).

### PRIOR ART DOCUMENT

### Patent Document

Patent Document 1: Japanese Patent Application Laid-Open (kokai) No. 2013-104649

### SUMMARY OF THE INVENTION

### Problem to be Solved by the Invention

However, in a case where a plurality of ceramic heaters are provided in the liquid heating device, if the safety device is provided for each heater, the size of the liquid heating device is increased. Meanwhile, if safety devices whose number is smaller than the number of heaters are provided, there is a possibility that abnormal temperature increase of any of the heaters cannot be sufficiently detected, depending on the positions of the safety devices.

Accordingly, an object of the present invention is to provide a liquid heating device that achieves size reduction and enables heater energization to be assuredly interrupted at the time of abnormality, while a safety device is provided for a plurality of ceramic heaters.

### Means for Solving the Problem

In order to solve the above problem, a liquid heating device of the present invention is a liquid heating device comprising: a container having an internal space, and an inlet and an outlet which communicate with the internal space; a plurality of ceramic heaters which extend in a front-rear direction and whose front-end portions are located in the internal space, the ceramic heaters having heat generation portions at the front-end portions; and a safety device configured to interrupt energization to the ceramic heaters when a temperature of the container has exceeded a set value, wherein in a process in which a liquid is introduced from the inlet and flows through the internal space to the outlet, the liquid is heated by the ceramic heaters, the ceramic heaters are arranged side by side with each other along the front-rear direction, the safety device whose number is smaller than a number of the ceramic heaters is provided on an outer side of the container or buried in the container, and in a cross-section crossing the front-rear direction, one said safety device is provided inside an area between two lines which pass centers of gravity of at least a pair of two adjacent ones of the ceramic heaters and which are perpendicular to a segment connecting the centers of gravity.

With this liquid heating device, since the safety device whose number is smaller than the number of the ceramic heaters is provided, the size of the liquid heating device can be reduced as compared to a case of providing safety devices whose number is the same as ceramic heaters.

In addition, since one safety device is provided inside the area for at least a pair of two adjacent ceramic heaters, the safety device is close to both of the pair of two adjacent ceramic heaters. Thus, abnormal temperature increase of each ceramic heater can be sufficiently detected, and heater energization can be assuredly interrupted at the time of abnormality.

In the liquid heating device of the present invention, the safety device may be provided on an outer side of the container, a heat-transfer medium having a thermal conductivity higher than a thermal conductivity of the container may be further provided between the safety device and the container, and an outer surface of the container in the area may have a recess at a part contacting with the heat-transfer medium.

With this liquid heating device, since the heat-transfer medium for transferring heat of the ceramic heaters to the safety device is interposed in the recess, the heat-transfer medium becomes closer to the ceramic heaters, whereby abnormal temperature increase of each ceramic heater can be more assuredly detected.

In the liquid heating device of the present invention, at least a part of the safety device may be located on an inner side of the recess.

With this liquid heating device, since a part of the safety device is present in the recess, the safety device becomes closer to the ceramic heaters, whereby abnormal temperature increase of each ceramic heater can be assuredly detected.

### Advantageous Effects of the Invention

According to the present invention, it becomes possible to provide a liquid heating device that achieves size reduction and enables heater energization to be assuredly interrupted at the time of abnormality, while a safety device is provided for a plurality of ceramic heaters.

### BRIEF DESCRIPTION OF THE DRAWINGS

FIG. 1 Perspective view showing the outer appearance of a liquid heating device according to the first embodiment of the present invention.

FIG. 2 See-through view along line A-A in FIG. 1.

FIG. 3 Sectional view along line B-B in FIG. 1.

FIG. 4 Sectional view along line C-C in FIG. 3.

FIG. 5 Sectional view along line D-D in FIG. 3.

FIG. 6 Sectional view along line E-E in FIG. 3.

FIG. 7 Schematic diagram showing a connection circuit of ceramic heaters and a safety device.

FIG. 8 Perspective view showing the outer appearance of a ceramic heater.

FIG. 9 Exploded perspective view showing the configuration of the ceramic heater.

FIG. 10 Sectional view showing a liquid heating device according to the second embodiment of the present invention.

FIG. 11 Perspective view showing the outer appearance of a liquid heating device according to the third embodiment of the present invention.

FIG. 12 Sectional view showing a liquid heating device according to the third embodiment of the present invention.

FIG. 13 Schematic diagram showing a connection circuit of ceramic heaters and safety devices of the liquid heating device according to the third embodiment.

FIG. 14 Sectional view showing a liquid heating device according to the fourth embodiment of the present invention.

FIG. 15 Schematic diagram showing a connection circuit of ceramic heaters and safety devices in a liquid heating device having four ceramic heaters.

FIG. 16 Sectional view showing a modification of the liquid heating device according to the third embodiment.

### MODES FOR CARRYING OUT THE INVENTION

Hereinafter, an embodiment of the present invention will be described.

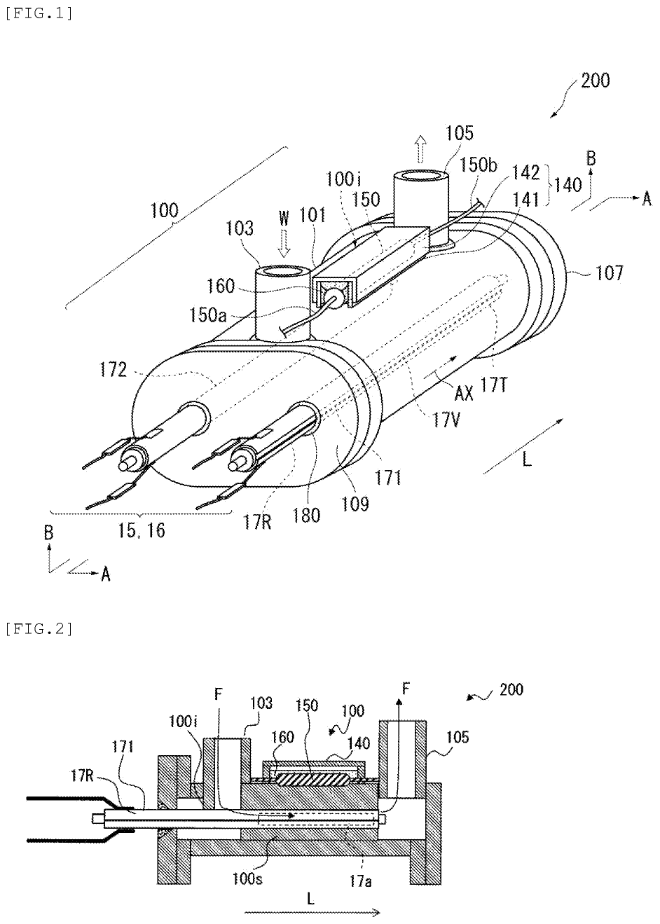

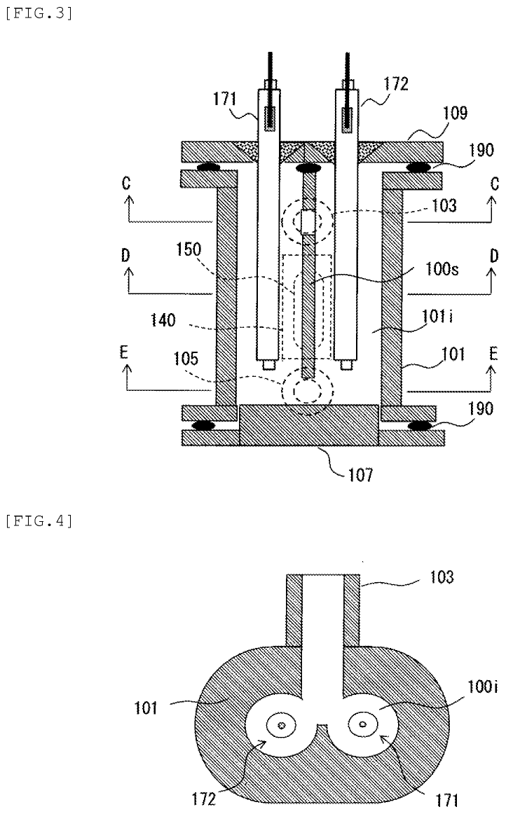

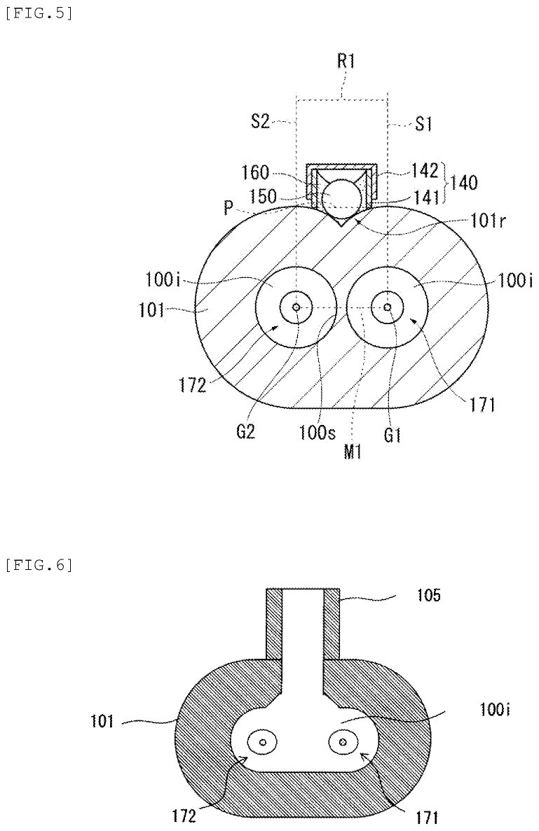

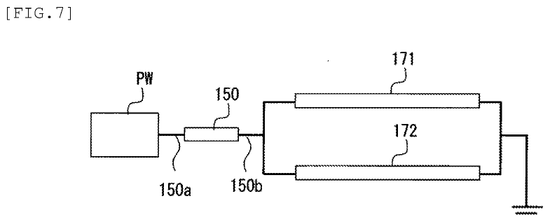

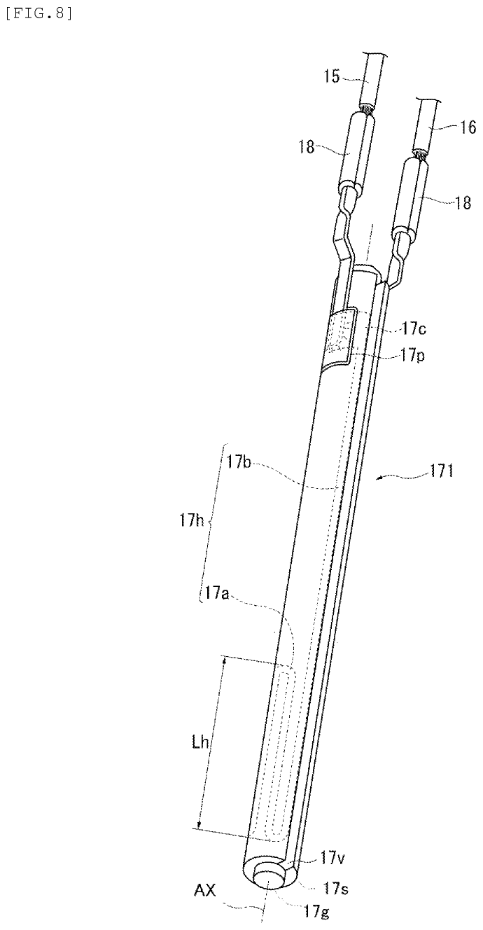

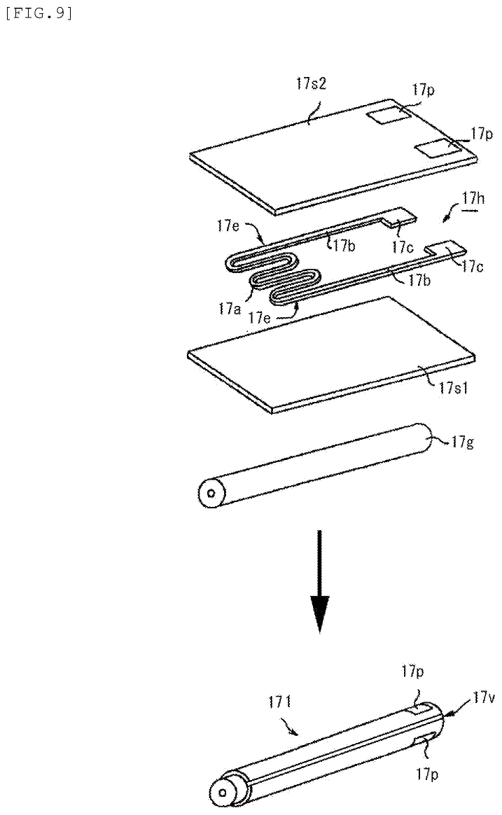

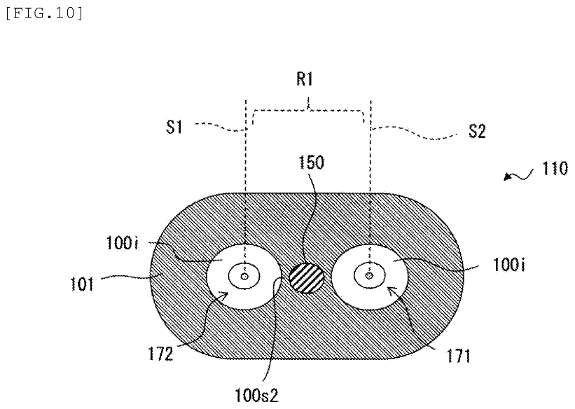

FIG. 1 is a perspective view of a liquid heating device 200 according to the first embodiment of the present invention. FIG. 2 is a see-through view along line A-A in FIG. 1. FIG. 3 is a sectional view along line B-B in FIG. 1. FIG. 4 is a sectional view along line C-C in FIG. 3. FIG. 5 is a sectional view along line D-D in FIG. 3. FIG. 6 is a sectional view along line E-E in FIG. 3. FIG. 7 is a schematic diagram showing a connection circuit of ceramic heaters 171, 172 and a safety device 150. FIG. 8 is a perspective view showing the outer appearance of a ceramic heater 171. FIG. 9 is an exploded perspective view of the ceramic heater 171.

In this first embodiment, the liquid heating device 200 is provided to a warm water washing toilet seat, and heats ordinary-temperature water by two built-in ceramic heaters 171, 172, to supply warm water.

The liquid heating device 200 has substantially an oblong tubular shape (a tubular shape whose cross-section is a rectangle with rounded corners) extending in an axial-line-L direction in its entirety, and has a container 100, two ceramic heaters 171, 172, and one safety device 150.

The container 100 has an oblong tubular trunk portion 101 having an internal space 100i for storing a liquid W (water), a front-end lid 107 and a rear-end lid 109 that close openings at both ends in the axial direction of the trunk portion 101, and an inlet 103 and an outlet 105 for the liquid W which are provided integrally with the trunk portion 101.

Both ends in the axial direction of the trunk portion 101 protrude in a flange shape in the radial direction. Both ends of the trunk portion 101, and the front-end lid 107 and the rear-end lid 109, are respectively sealed with each other in an airtight state by O rings 190 (FIG. 3).

The ceramic heaters 171, 172 have rod shapes extending in an front-rear direction AX, and are arranged side by side toward the same direction (in parallel) along the front-rear direction AX. A base-end portion 17R of each ceramic heater 171, 172 is retained in a cantilever manner by a sealing portion 180 at an opening of the rear-end lid 109 of the container 100, whereby each ceramic heater 171, 172 is attached to the container 100.

A front-end portion 17T of each ceramic heater 171, 172 is located in the internal space 100i. Needless to say, the retained part by the sealing portion 180 is on the base-end side relative to a heat generation portion 17a of the ceramic heater described later.

Lead wires 15, 16 described later for supplying power from outside are connected to the base-end portion 17R sides of the ceramic heaters 171, 172.

In this example, the axial direction of the trunk portion 101 is parallel to the axial-line-L direction, and the ceramic heaters 171, 172 are stored in the internal space 100i of the trunk portion 101 such that the direction (the front-rear direction AX) in which the ceramic heaters 171, 172 are arranged side by side is along the axial-line-L direction.

Although not shown, in this example, the liquid heating device 200 is provided to the warm water washing toilet seat such that the axial-line-L direction is substantially the horizontal direction and the outlet 105 side is located slightly upward, and the ceramic heaters 171, 172 are laid horizontally.

The inlet 103 and the outlet 105 communicate with the internal space 100i and are located apart from each other in the axial-line-L direction. The liquid W introduced through the inlet 103 from outside passes through the internal space 100i along the axial-line-L direction and then is discharged from the outlet 105.

A gap is formed between the inner wall of the container 100 and each ceramic heater 171, 172. The liquid W introduced into the internal space 100i through the inlet 103 contacts with the outer surfaces of the ceramic heaters 171, 172 along the axial-line-L direction, thus being heated, and then the liquid W flows to the outlet 105.

As shown in FIG. 2, since the inlet 103 and the outlet 105 are located in the front-rear direction AX (=axial-line-L direction) of the ceramic heaters 171, 172, water introduced from the inlet 103 flows to the front-end portion 17T side while contacting with the outer surfaces of the ceramic heaters 171, 172, toward the outlet 105.

FIG. 2 is a view as seen through in a direction perpendicular to the axial-line-L direction and the axial line of the inlet 103.

Here, the safety device 150 whose number is smaller (in this example, one) than the number of the ceramic heaters 171, 172 (in this example, two) is provided on the outer side of the container 100.

Specifically, a box-shaped grease case 140 is formed integrally on the outer surface of the container 100 between the inlet 103 and the outlet 105, and thermal grease (heat-transfer medium) 160 is included inside the grease case 140. The safety device 150 is buried in the thermal grease 160.

As shown in FIG. 1, the grease case 140 includes a box-shaped storage portion 141 which opens on the upper side, and a cover 142 which covers the upper side of the storage portion 141. The storage portion 141 is integrated with the container 100.

After the thermal grease 160 and the safety device 150 are placed in the storage portion 141 which opens on the upper side, the cover 142 is attached thereto.

The safety device 150 may be configured to interrupt energization to the ceramic heaters 171, 172 when the temperature of the container 100 exceeds a set value.

In this example, the safety device 150 is a known pellet-type thermal fuse, and a first lead wire 150a and a second lead wire 150b extend from both ends of the safety device 150. Of the storage portion 141, parts of wall surfaces respectively facing the inlet 103 and the outlet 105 are cut out, and the first lead wire 150a and the second lead wire 150b are exposed to outside through the respective cutouts.

As shown in FIG. 7, at the safety device 150, the first lead wire 150a is connected on the side of a power supply PW for the ceramic heaters 171, 172, and the two ceramic heaters 171, 172 are connected in parallel to the second lead wire 150b. The first lead wire 150a may be connected to the ground side and the second lead wire 150b may be connected to the side of the power supply PW.

The thermal conductivity of the heat-transfer medium 160 such as thermal grease is higher than the thermal conductivity of the container 100. The heat-transfer medium is not limited to thermal grease, and may be a heat-transfer medium made of resin and metal powder, for example. The heat-transfer medium such as thermal grease may be a curable type. In a case of a curable type, the grease case 140 is not needed and the safety device 150 may be retained at the outer surface of the container 100 via the curable-type heat-transfer medium.

An example of the curable-type heat-transfer medium is curable-type silicone thermal grease.

Next, as shown in FIG. 3, in the internal space 100i between the inlet 103 and the outlet 105, a separation wall 100s is provided for separating the plurality of ceramic heaters 171, 172 one by one from each other, so that the water introduced from the inlet 103 flows for each ceramic heater 171, 172 in the separation wall 100s.

As shown in FIG. 6, in the internal space 100i near the outlet 105, the separation wall 100s is not provided and therefore a single internal space 100i is formed. Thus, near the outlet 105, the volume of the internal space 100i increases, so that boiling bubbles generated on the inlet 103 side is readily discharged from the outlet 105 to outside. In addition, flows of water heated in each individual separation wall 100s merge together, thus obtaining warm water having uniform temperature.

FIG. 3 is a sectional view taken along the axial-line-L direction so as to pass the center of the minor axis of the liquid heating device 200. FIG. 4 and FIG. 6 are sectional views perpendicular to the axial-line-L direction in FIG. 3.

Next, with reference to FIG. 5, the positional relationship between the ceramic heaters 171, 172 and the safety device 150 will be described.

As shown in FIG. 5, in a cross-section crossing the front-rear direction AX (in this example, equal to axial-line-L direction), a segment M1 is drawn so as to connect centers of gravity G1, G2 of a pair of two adjacent ceramic heaters 171, 172. Next, two lines S1, S2 are drawn perpendicularly to the segment M1 so as to pass the centers of gravity G1, G2, respectively.

One safety device 150 is provided inside an area R1 between the lines S1, S2.

Thus, since the safety device 150 whose number is smaller than the number of the ceramic heaters 171, 172 is provided, the size of the liquid heating device 200 can be reduced as compared to a case of providing safety devices whose number is the same as the number of ceramic heaters.

In addition, since one safety device 150 is provided inside the area R1 for at least a pair of two adjacent ceramic heaters 171, 172, the safety device 150 is close to both of the pair of two adjacent ceramic heaters 171, 172. Thus, abnormal temperature increase of each ceramic heater 171, 172 can be sufficiently detected, and heater energization can be assuredly interrupted at the time of abnormality.

As shown in FIG. 5, in this example, the outer surface of the container 101 in the area R1 has a recess 101r at a part contacting with the heat-transfer medium 160.

Thus, the heat-transfer medium 160 for transferring heat of the ceramic heaters 171, 172 to the safety device 150 is interposed in the recess 101r, so that the heat-transfer medium 160 becomes closer to the ceramic heaters 171, 172, whereby abnormal temperature increase of each ceramic heater 171, 172 can be more assuredly detected.

In this example, the recess 101r has substantially a wedge shape in which the intersection part of circles enclosing the respective ceramic heaters 171, 172 is the deepest. The recess 101r is provided on the inner side of the storage portion 141.

Regarding discrimination between a recess and a non-recess, in a cross-section crossing the front-rear direction AX of the container 101, if the contour of the container 101 at a part where the heat-transfer medium 160 is interposed is at least partially present on the inner side of the container 101 (side close to ceramic heaters 171, 172) from an approximation curve P passing the contour of the container 101 at a part where the heat-transfer medium 160 is not interposed, the inner side part is regarded as a recess.

As shown in FIG. 5, in this example, at least a part (in FIG. 5, the bottom side) of the safety device 150 is located on the inner side of the recess 101r.

Thus, a part of the safety device 150 is present in the recess 101r, so that the safety device 150 becomes closer to the ceramic heaters 171, 172, whereby abnormal temperature increase of the ceramic heaters 171, 172 can be more assuredly detected.

Next, with reference to FIG. 8 and FIG. 9, the configuration of the ceramic heater will be described. The ceramic heaters 171, 172 have the same shape and therefore the ceramic heater 171 will be described.

As shown in FIG. 8, the ceramic heater 171 has a heat generation body 17h which generates heat by being energized from outside via the lead wires 15, 16. The heat generation body 17h has, on the front-end side, the heat generation portion 17a formed by meandering a conductor in the front-rear direction AX as a heat generation pattern, and has a pair of lead portions 17b led from both ends of the heat generation portion 17a to the rear-end side.

The heat generation portion 17a has a length of Lh in the front-rear direction AX.

More specifically, as shown in FIG. 9, the heat generation body 17h has the heat generation portion 17a, both lead portions 17b, and electrode patterns 17c formed at rear ends of both lead portions 17b, and the heat generation body 17h is held between two ceramic green sheets 17s1, 17s2. As the ceramic green sheets, alumina is used. As the heat generation portion 17a and the lead portions 17b, tungsten, rhenium, or the like is used. Two electrode pads 17p to which lead terminals 18 (see FIG. 8) are to be brazed are formed on the front surface of the ceramic green sheet 17s2, and the electrode patterns 17c are connected to the electrode pads 17p via through holes, thus forming a laminated body of the ceramic green sheets.

Further, this laminated body is wrapped around a rod-shaped ceramic base 17g mainly composed of alumina, etc., with the ceramic green sheet 17s2 set on the front side, and then these are sintered, whereby the ceramic green sheets 17s1, 17s2 form a ceramic sheet 17s wrapped around the outer circumference of the ceramic base 17g so as to be integrated and thus the ceramic heater 171 can be produced.

The ceramic base 17g may have a tubular shape having a through hole, or a columnar shape with no hole. In a case of a tubular shape, it is desirable to make sealing with resin or the like so as not to leak water from the through hole.

The lead wires 15, 16 are crimped with the lead terminals 18 so as to be electrically connected thereto (see FIG. 8).

Here, in wrapping the laminated body around the ceramic base 17g, the laminated body is wrapped such that both ends along the front-rear direction AX of the laminated body are spaced from each other. Thus, at a wrap-meeting part on the outer surface of the ceramic heater 171, a slit 17v forming a recessed groove along the front-rear direction AX is formed as a non-heat generation portion.

Therefore, as seen in the cross-section of the ceramic heater 171 along the radial direction, the heat generation portion 17a is embedded in the ceramic heater 171 so as to form a ring shape having ends, and the slit 17v as a non-heat generation portion is formed between two ring ends 17e of the heat generation portion 17a.

Next, with reference to FIG. 10, a liquid heating device according to the second embodiment of the present invention will be described.

FIG. 10 is a sectional view of the liquid heating device according to the second embodiment of the present invention, and is a sectional view corresponding to FIG. 5.

The liquid heating device according to the second embodiment of the present invention is the same as the liquid heating device 200 according to the first embodiment except that the placement position of the safety device 150 and thus the configuration of a container 110 are different. Therefore, the same parts as those of the liquid heating device 200 are denoted by the same reference characters and the description thereof is omitted.

As shown in FIG. 10, in the liquid heating device according to the second embodiment, one safety device 150 is buried in the container 110. Specifically, the interval between the ceramic heaters 171, 172 is expanded so that a separation wall 100s2 wider than the separation wall 100s of the container 100 shown in FIG. 3 in the first embodiment is formed, and the safety device 150 is buried in the separation wall 100s2.

Also in the second embodiment, since the safety device 150 whose number is smaller than the number of the ceramic heaters 171, 172 is provided, the size of the liquid heating device can be reduced as compared to a case of providing safety devices whose number is the same as the number of ceramic heaters.

In addition, since one safety device 150 is provided inside the area R1, the safety device 150 is close to both of the pair of two adjacent ceramic heaters 171, 172. Thus, abnormal temperature increase of each ceramic heaters 171, 172 can be sufficiently detected, and heater energization can be assuredly interrupted at the time of abnormality.

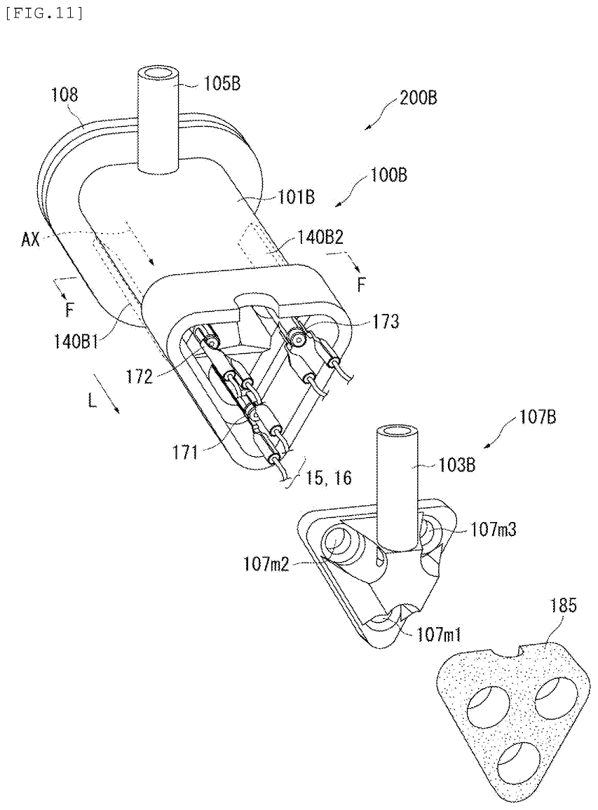

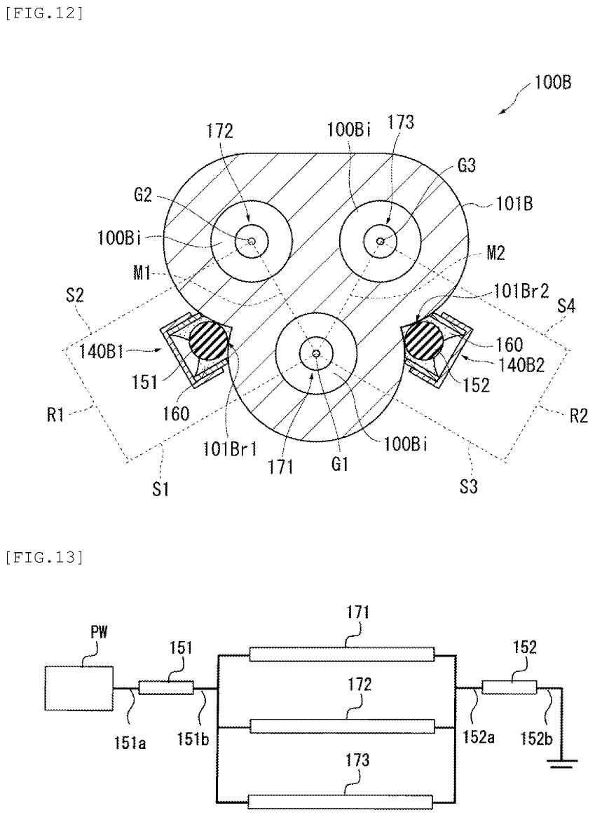

Next, with reference to FIG. 11 and FIG. 12, a liquid heating device 200B according to the third embodiment of the present invention will be described.

FIG. 11 is a perspective view showing the outer appearance of the liquid heating device 200B, and FIG. 12 is a sectional view of the liquid heating device 200B. FIG. 12 is a sectional view corresponding to FIG. 5 in the first embodiment.

The liquid heating device 200B is the same as the liquid heating device 200 according to the first embodiment except that three ceramic heaters 171, 172, 173 and two safety devices 151, 152 are provided and the configuration of a container 100B is different. Therefore, the same parts as those of the liquid heating device 200 are denoted by the same reference characters and the description thereof is omitted.

As shown in FIG. 11, the liquid heating device 200B includes the container 100B having substantially a triangular tubular shape (a tubular shape whose cross-section is a triangle) in its entirety, and the three ceramic heaters 171 to 173.

The container 100B has an oblong tubular trunk portion 101B having an internal space 100i for storing a liquid (water), a front-end lid 107B and a rear-end lid 108 that close openings at both ends in the axial-line-L direction of the trunk portion 101B, and an inlet 103B and an outlet 105B for the liquid W.

The inlet 103B and the outlet 105B are provided integrally with the front-end lid 107B and the trunk portion 101B, respectively. The front-end lid 107B is fitted to the front end in the axial-line-L direction of the trunk portion 101 (end on the side where the ceramic heaters 171 to 173 are exposed).

On the other hand, at the rear end in the axial direction of the trunk portion 101, the rear-end lid 108 is sealed in a liquid-tight state via a rubber seal such as a packing, for example.

The three ceramic heaters 171 to 173 have rod shapes extending in the front-rear direction AX, and extend in the same direction (in parallel). Base-end portions 17R of the ceramic heaters 171 to 173 penetrate three openings 107m1 to 107m3 of the front-end lid 107B. Gaps between the ceramic heaters 171 to 173 and the openings 107m1 to 107m3 are sealed by a fixation member 185 made of epoxy resin, whereby the ceramic heaters 171 to 173 are fixed to the container 100 in a cantilever manner.

In this example, the ceramic heaters 171 to 173 are stored in the internal space 100i of the trunk portion 101 such that the front-rear direction AX, i.e., the direction in which the ceramic heaters 171 to 173 are arranged side by side, is along the axial-line-L direction of the trunk portion 101.

The inlet 103B and the outlet 105B communicate with the internal space 100Bi (FIG. 12) and are located apart from each other in the axial-line-L direction. The liquid introduced through the inlet 103B from outside passes through the internal space 100Bi along the axial-line-L direction and then is discharged from the outlet 105B.

A gap is formed between the inner wall of the container 100 and each ceramic heater 171 to 173. The liquid introduced into the internal space 100Bi through the inlet 103 contacts with the outer surfaces of the ceramic heaters 171 to 173 along the axial-line-L direction, thus being heated, and then the liquid flows to the outlet 105.

Here, as shown in FIG. 12, the safety devices 151, 152 whose number is smaller (in this example, two) than the number of the ceramic heaters 171 to 173 (in this example, three) are provided on the outer side of the container 100B. Specifically, as shown in FIG. 11, box-shaped grease cases 140B1, 140B2 are formed integrally on two of three outer surfaces of the container 100B between the inlet 103B and the outlet 105B. The grease cases 140B1, 140B2 have the same structure as that of the grease case 140 in the first embodiment.

As in the first embodiment, the thermal grease (heat-transfer medium) 160 is included inside each grease case 140B1, 140B2. Each safety device 151, 152 is buried in the thermal grease 160.

Next, with reference to FIG. 12, the positional relationship between the ceramic heaters 171 to 173 and the safety devices 151, 152 will be described.

As shown in FIG. 12, in a cross-section crossing the front-rear direction AX (in this example, equal to axial-line-L direction), a segment M1 is drawn so as to connect centers of gravity G1, G2 of a pair of two adjacent ceramic heaters 171, 172, and two lines S1, S2 are drawn. Then, one safety device 151 is provided inside an area R1 between the lines S1, S2.

Similarly, also for another pair of two adjacent ceramic heaters 171, 173, two lines S3, S4 are drawn perpendicularly to a segment M2 so as to pass their centers of gravity G1, G3, respectively. Then, another safety device 152 is provided inside an area R2 between the lines S3, S4.

Thus, since the safety devices 151, 152 whose number is smaller than the number of the ceramic heaters 171 to 173 are provided, the size of the liquid heating device 200B can be reduced as compared to a case of providing safety devices whose number is the same as the number of ceramic heaters.

In addition, one safety device 151 is provided inside the area R1 for a pair of two adjacent ceramic heaters 171, 172, and one safety device 152 is provided inside the area R2 for another pair of two adjacent ceramic heaters 171, 173. Therefore, the safety device 151 is close to both of the pair of two adjacent ceramic heaters 171, 172, and similarly, the safety device 152 is close to both of the other pair of two adjacent ceramic heaters 171, 173. Thus, abnormal temperature increase of each ceramic heater 171 to 173 can be sufficiently detected, and heater energization can be assuredly interrupted at the time of abnormality.

As shown in FIG. 12, also in this example, the outer surface of the container 101B in the area R1 has a recess 101Br1 at a part contacting with the heat-transfer medium 160. Similarly, the outer surface of the container 101B in the area R2 has a recess 101Br2 at a part contacting with the heat-transfer medium 160.

Thus, the heat-transfer medium 160 for transferring heat of the ceramic heaters 171, 172 to the safety device 151 is interposed in the recess 101Br1. Similarly, the heat-transfer medium 160 for transferring heat of the ceramic heaters 171, 173 to the safety device 152 is interposed in the recess 101Br2. Therefore, the heat-transfer mediums 160 become closer to the ceramic heaters 171 to 173, whereby abnormal temperature increase of each ceramic heater 171 to 173 can be more assuredly detected.

Also in this example, the recesses 101Br1, 101Br2 respectively have substantially wedge shapes in which the intersection part of circles enclosing the ceramic heaters 171, 172 and the intersection part of circles enclosing the ceramic heaters 171, 173 are the deepest. The recesses 101Br1, 101Br2 are provided on the inner sides of the storage portions of the grease cases 140B1, 140B2, respectively.

As shown in FIG. 12, also in this example, at least parts (in FIG. 5, the bottom sides) of the safety devices 151, 152 are located on the inner sides of the recesses 101Br1, 101Br2, respectively.

Thus, parts of the safety devices 151, 152 are present in the recesses 101Br1, 101Br2, so that the safety devices 151, 152 become closer to the ceramic heaters 171 to 173, whereby abnormal temperature increase of each ceramic heater 171 to 173 can be more assuredly detected.

As shown in FIG. 13, at the safety device 151, a first lead wire 151a is connected on the side of the power supply PW for the ceramic heaters 171 to 173, and the three ceramic heaters 171 to 173 are connected in parallel to the second lead wire 151b. At the safety device 152, the three ceramic heaters 171 to 173 are connected in parallel to a first lead wire 152a, and a second lead wire 152b is connected to the ground side.

The ceramic heater 173 may be directly connected to the side of the power supply PW not via the safety device 151, and the ceramic heater 172 may be directly connected to the ground side not via the safety device 152.

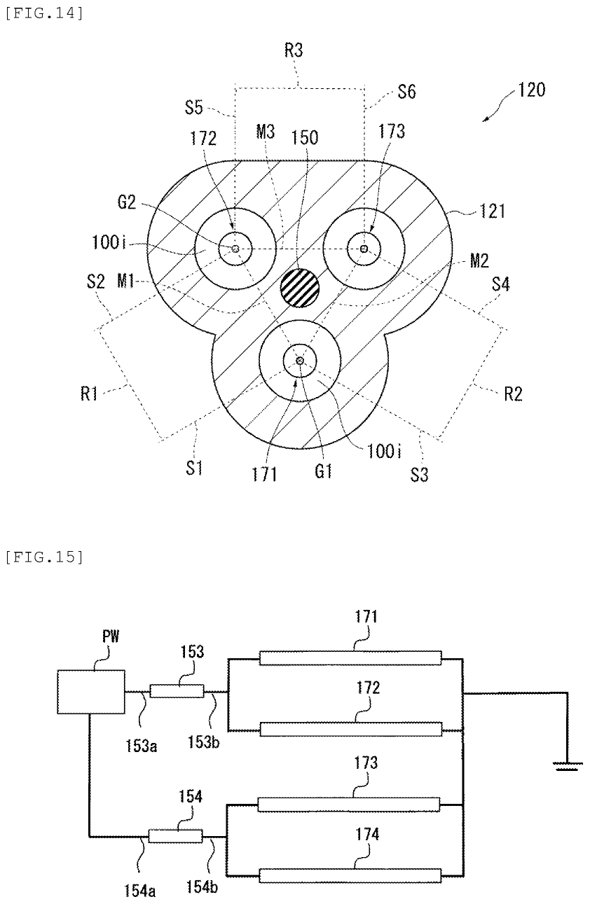

Next, with reference to FIG. 14, a liquid heating device according to the fourth embodiment of the present invention will be described.

FIG. 14 is a sectional view of the liquid heating device according to the fourth embodiment of the present invention, and is a sectional view corresponding to FIG. 5.

The liquid heating device according to the fourth embodiment of the present invention is the same as the liquid heating device 200B according to the third embodiment except that the placement position of the safety device 150 and thus the configuration of a container 120 are different. Therefore, the same parts as those of the liquid heating device 200B are denoted by the same reference characters and the description thereof is omitted.

As shown in FIG. 14, in the liquid heating device according to the fourth embodiment, one safety device 150 is buried in the container 120. Specifically, the intervals between the ceramic heaters 171 to 173 are expanded so that a separation wall 120s of the container 100 surrounded by the ceramic heaters 171 to 173 is made wider, and the safety device 150 is buried in the separation wall 120s.

Also in the fourth embodiment, since the safety device 150 whose number is smaller than the number of the ceramic heaters 171 to 173 is provided, the size of the liquid heating device can be reduced as compared to a case of providing safety devices whose number is the same as the number of ceramic heaters.

It should be understood that the present invention is not limited to the above embodiments and incorporates various modifications and equivalents within the idea and the scope of the present invention.

For example, in the third embodiment, without the safety device 152, one safety device 151 may be provided for three ceramic heaters 171 to 173.

As shown in FIG. 15, for example, two safety devices 153, 154 may be provided for four ceramic heaters 171 to 174. Then, as in FIG. 12, one safety device 154 may be provided inside the area R2 for a pair of the ceramic heaters 173, 174.

In this case, an example of a connection circuit of the ceramic heaters 171 to 174 and the safety devices 153, 154 is as follows. At the safety device 153, a first lead wire 153a is connected on the side of the power supply PW for the ceramic heaters 171, 172, and two ceramic heaters 171, 172 are connected in parallel to a second lead wire 153b. At the safety device 154, a first lead wire 154a is connected on the side of the power supply PW for the ceramic heaters 173, 174, and two ceramic heaters 173, 174 are connected in parallel to the second lead wire 154b.

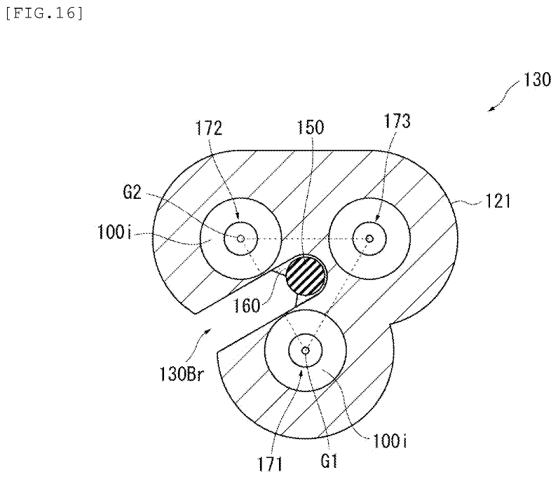

As shown in FIG. 16, as a modification of the liquid heating device according to the third embodiment, one recess 130Br may be provided and the recess 130Br may extend deeply to the center of a container 130 surrounded by the ceramic heaters 171 to 173.

In this example, one safety device 150 is provided at the deepest part of the recess 130Br, and the heat-transfer medium 160 is interposed between the recess 130Br and the safety device 150.

### Example

The liquid heating device 200 shown in FIG. 1 was produced.

First, as raw-material ceramic for the ceramic heater, alumina powder and glass-component powder serving as a sintering aid were crushed and mixed with water by a mill, and then were mixed with a binder, to obtain a clay-like mixture. The clay-like mixture was extruded by an extruder using a die with a core placed therein, to form a tubular ceramic base, which was then cut into a predetermined length and calcined. The outer diameter and the length of the ceramic base were adjusted in consideration of a sintering shrinkage factor.

Meanwhile, on an alumina green sheet, a heater pattern and a terminal portion connected thereto and leading to a sheet opposite surface were printed and formed using a tungsten/molybdenum paste. Regarding the size of the heater printed area, dimensions were prescribed while a shrinkage factor in ceramic sintering was taken into consideration. The heater pattern was formed while calculating a resistance value at the room temperature from a resistance value at a high temperature and a resistance change amount (temperature coefficient of resistance x temperature difference x initial resistance value) corresponding to temperature increase. Also for the sheet size, a sintering shrinkage factor was considered, to prepare and cut the sheet.

The printed ceramic green sheet cut in a prescribed size was wrapped around the calcined ceramic base, and these were sintered integrally, so that a completed ceramic heater had a heater entire length LM=60 mm and a maximum outer diameter D=2.8 mm, and the room-temperature resistance value of the ceramic heater was 9 Q. The resistance value of the ceramic heater was adjusted by changing the length (number of times of folding) and the thickness of the heat generation portion. An exposed terminal portion of the heater sintered body was plated with Ni, and a lead portion made of Ni was brazed and joined thereto by Ag solder. Then, the lead wire was crimped with the lead portion, thus obtaining the ceramic heater.

Next, two ceramic heaters were attached to a container made of resin. Specifically, the respective ceramic heaters were caused to penetrate two through holes of the rear-end lid, and the ceramic heaters were fixed using an epoxy adhesive as the sealing portions. Then, the rear-end lid, the trunk portion, and the front-end lid were connected in an airtight state via O rings, thus producing the liquid heating device 200.

Further, as shown in FIG. 1 and FIG. 5, the thermal grease 160 and one safety device 150 were provided inside the grease case 140. The safety device 150 was provided inside the area R1 between the lines S1, S2 in FIG. 5.

To the obtained liquid heating device 200, water having a temperature of 5° C. was introduced at a flow rate of 450 cc/min, and application voltage per ceramic heater was controlled so that the flow-out warm-water temperature became 35° C.

Thereafter, water flow was stopped in a voltage applied state. As a result, the heater temperature increased, and when such a temperature set value that abnormality (thermal deformation) would not occur in the resin container was exceeded, the safety device 150 which was a fuse was disconnected and energization to the heaters was stopped. Thus, the temperature did not increase anymore and abnormality of the container was successfully prevented.

On the other hand, the safety device 150 was provided outside the area R1 between the lines S1, S2 in FIG. 5, and was located closer to one ceramic heater 171 side. In this case, even though the ceramic heater 172 on the side far from the safety device 150 was overheated and exceeded the temperature set value, the safety device 150 did not detect this, and after the temperature of the ceramic heater 172 further increased and a part of the container was thermally deformed, the safety device 150 detected this and was disconnected, so that heater energization was stopped.

As a result, the container was deformed and the resin of the container was partially burned.

### DESCRIPTION OF REFERENCE NUMERALS

17a heat generation portion
100,100B, 110, 120,130 container
1001, 100Bi internal space
101r, 101Br1, 101Br2, 130Br recess
103,103B inlet
105,105B outlet
150-154 safety device
160 heat-transfer medium
171-173 ceramic heater
200,200B liquid heating device
L front-rear direction
W liquid
G1-G3 center of gravity of the ceramic heater
M1, M2 segment connecting the centers of gravity
S1-S4 two lines
R1, R2 area

1. A liquid heating device comprising:
a container having an internal space, and an inlet and an outlet which communicate with the internal space;
a plurality of ceramic heaters which extend in a front-rear direction and whose front-end portions are located in the internal space, the ceramic heaters having heat generation portions at the front-end portions; and
a safety device configured to interrupt energization to the ceramic heaters when a temperature of the container has exceeded a set value, wherein
in a process in which a liquid is introduced from the inlet and flows through the internal space to the outlet, the liquid is heated by the ceramic heaters,
the ceramic heaters are arranged side by side with each other along the front-rear direction,
the safety device whose number is smaller than a number of the ceramic heaters is provided on an outer side of the container or buried in the container, and
in a cross-section crossing the front-rear direction, one said safety device is provided inside an area between two lines which pass centers of gravity of at least a pair of two adjacent ones of the ceramic heaters and which are perpendicular to a segment connecting the centers of gravity.

2. The liquid heating device according to claim 1, wherein
the safety device is provided on an outer side of the container,
a heat-transfer medium having a thermal conductivity higher than a thermal conductivity of the container is further provided between the safety device and the container, and
an outer surface of the container in the area has a recess at a part contacting with the heat-transfer medium.

3. The liquid heating device according to claim 2, wherein
at least a part of the safety device is located on an inner side of the recess.
